(19) United States
(12) Patent Application Publication
(10) Pub. No.: US 2008/0285206 A1
(43) Pub. Date: Nov. 20, 2008

(54) Vaux box

(76) Inventor: Kelsey Leacroft Brown, Union City, GA (US)

Correspondence Address: KELSEY BROWN, 9107 Valleyview Court, Union City, GA, 30291, US

(21) Appl. No.: 11/724,693

(22) Filed: May 18, 2007

(51) Int. Cl. H99Z 99/00

(52) U.S. Cl. 361/437

(57) ABSTRACT

This invention uses the new concept of converting RCA or YCbCr to your computer monitor (SCSI). Although all computers are different, the connection for the computer monitor may differ depending on the computer brand.

### BACKGROUND OF THE INVENTION

For as long as people have been using computers, the use of the computer monitor, has been limited for viewing from the CPU unit only. Though many computers come with plasma and high definition screens, people are stuck with having only one thing to watch on their computer screens, the CPU unit! There is nothing on the market that allows you to instantly use your computer monitor screen, as a monitor for other things. Like a Playstation, a home video recorder, and even digital cable/satellite.

### BRIEF SUMMARY OF THE INVENTION

Now, people are restricted and can only use their computer monitor, to monitor their computer. With my device The Vaux Box, people will now be able to use their computer or laptop monitor to view anything that uses a RCA or YCbCr output cable. Such as digital cable/satellite, Playstation, home video recorders, etc. With the Vaux Box, switching the view of each device on your computer monitor screen with the touch of a button. No need to download any software. Just plug and play!

### BRIEF DESCRIPTION OF SEVERAL VIEWS OF THE DRAWING

FIG. 1

A: This is the front of The Vaux Box.

B: It has a button that switches between the CPU, RCA, and YCbCr.

C: Other units will be made with more RCA and YCbCr inputs.

FIG. 2

A: This is a RCA input.

FIG. 3

A: This is a YCbCr input.

FIG. 4

A: This is the computer monitor output cable.

B: This cable connects to the CPU or Laptop where the monitor normally goes.

C: The cable will differ in size depending on the brand of computer. (Mac/PC)

FIG. 5

A: This view shows the back of The Vaux Box.

FIG. 6

A: This is the computer monitor output cable as shown on FIG. 4

FIG. 7

A: This is the computer monitor input.

B: This is where you plug in the computer monitor itself.

C: The input port will differ depending on the brand of computer. (Mac/PC)

FIG. 8

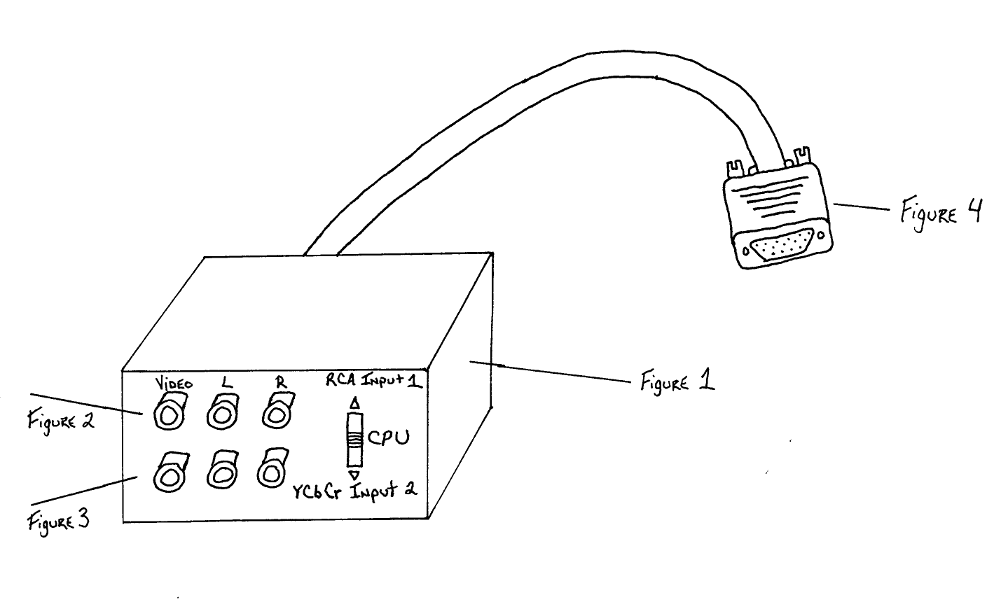

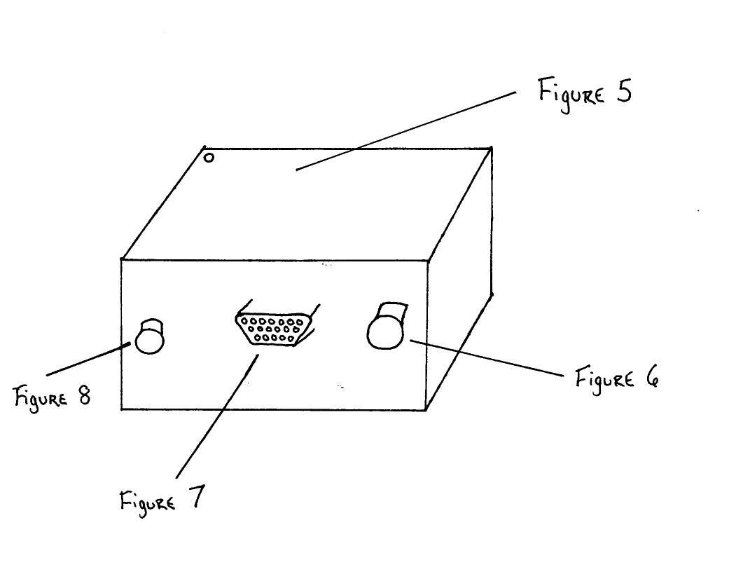

A: Power line.

### DETAILED DESCRIPTION OF THE INVENTION

The Vaux Box is a device that you route your computer monitor through. The Vaux Box allows you to instantly switch between different RCA, YCbCr inputs and the CPU Unit on your computer monitor instantly.

How It Works: You can plug in any electronic device that uses a RCA or YCbCr output. Such as, Playstations, home video recorders, digital cable, etc. The Vaux Box allows you to instantly switch between RCA, YCbCr, and the CPU unit to view on any home computer monitor or laptop with the touch of a button. For example, If you have a Playstation plugged in RCA input 1 on The Vaux Box and digital cable plugged in RCA input 2 on The Vaux Box, you can instantly switch between RCA or YCbCr inputs to view on your computer monitor screen. Or switch to the CPU to view the CPU unit itself. All you have to do is plug you computer monitor into the back of The Vaux Box and plug The Vaux Box output line where you would normally plug in your computer monitor on your CPU unit.

1. What I claim as my invention is the Vaux Box. The Vaux Box is a device that allows you to use your computer or laptop monitor as a video-audio monitor for electronic devices other than the CPU itself. Devices that use RCA and YCbCr cable outputs such as, Playstations, home video recorders, digital cable, etc. The Vaux Box allows you to switch between each device instantly to view on your laptop or computer monitor screen.
